(19) United States
(12) Patent Application Publication
(10) Pub. No.: US 2003/0217141 A1
(43) Pub. Date: Nov. 20, 2003

(54) Loop compensation for a network topology

(76) Inventors: Shiro Suzuki, Folsom, CA (US); Ravendra Gorijala, Sunnyvale, CA (US); Manoj K. Wadekar, San Jose, CA (US)

Correspondence Address: KENYON & KENYON, Suite 700, 1500 K Street, N.W., Washington, DC, 20005-1257, US

(21) Appl. No.: 10/143,801

(22) Filed: May 14, 2002

(51) Int. Cl. G06F 15/173

(52) U.S. Cl. 709/224

(57) ABSTRACT

A network includes a plurality of edge switches, one or more core switches, and a plurality of core links that couple the edge switches to the core switches. The core links at each of the edge switches are link aggregated together in order to compensate for any loops in the network.

### FIELD OF THE INVENTION

One embodiment of the present invention is directed to a network. More particularly, one embodiment of the present invention is directed to compensating for loops in a network topology.

### BACKGROUND INFORMATION

Networks are formed of switches that relay packets between devices. A particular switch has a finite capacity or bandwidth of packets that it can switch in a fixed amount of time. In order to increase the bandwidth, some switches can be interconnected together to form a switch stack, which is essentially a switch network. The switches that form the stack cooperate to perform the function of a single large switch.

The physical layout of the switches in a stack or in any network is referred to as the network topology. Many different types of network topologies exist. Examples of network topologies include a star topology, a bus topology, a tree topology, etc.

One problem with some network topologies is that they include loops. Loops are caused by multiple active paths between switches in a network. If a loop exists in the switch topology, the potential exists for duplication of messages. The result is wasted resources in the network, a decrease in speed of the network, and a possible infinite circulation of packets which can result in a saturation of the network.

In order to compensate for loops in some switch stack networks, some vendors use special wiring and protocols to connect each of the switches. However, this increases the complexity of the stack switches and therefore increases the costs.

Based on the foregoing, there is a need for an improved system and method for compensating for loops in a switch network.

### BRIEF DESCRIPTION OF THE DRAWINGS

FIG. 1 is an overview diagram of a network in accordance with one embodiment of the present invention.

FIG. 2 is a flow diagram of the functionality performed by a network in accordance with one embodiment of the present invention.

FIG. 3 is an overview diagram of a switch topology network that includes core switches and edge switches.

### DETAILED DESCRIPTION

One embodiment of the present invention is a system and method for compensating for loops in a switch network. In one embodiment, the switch is a stackable switch that forms a Star-Wired-Matrix network topology with the switches interconnected using Ethernet.

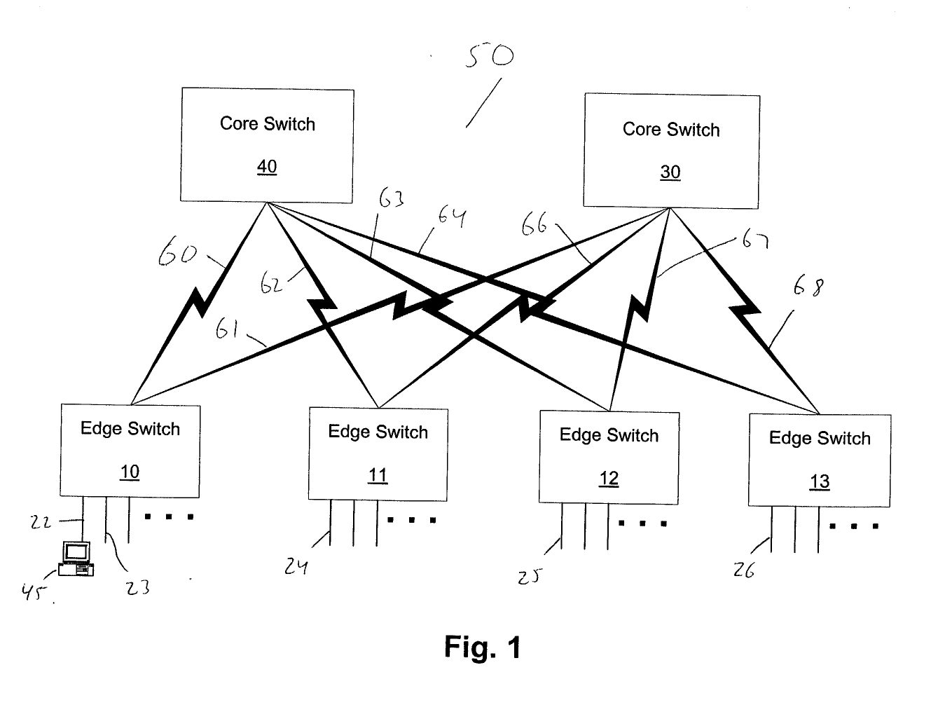

FIG. 1 is an overview diagram of a network 50 in accordance with one embodiment of the present invention. Network 50 includes four edge switches 10-13 and two core switches 30 and 40. In one embodiment, all of the switches 10-13, 30 and 40 are Ethernet switches that have twenty-eight total ports. Four of the ports are high speed Gigabit Ethernet ports, and twenty-four of the ports are lower speed 10/100 Mb Ethernet ports. In one embodiment each switch includes a processor and memory.

Switches 10-13, 30 and 40 are coupled together via links 60-68 that are coupled to the ports of the switches. In one embodiment, core switches 30 and 40 have links coupled to only the high speed ports of the switches. In one embodiment, core switches 30 and 40 have links that couple each core switch 30, 40 to each edge switch 10-13. Core switch 40 has links 60, 62-64 that couple core switch 40 to edge switches 10, 11, 12 and 13, respectively. Core switch 30 has links 61, 66-68 that couple core switch 30 to edge switches 10, 11, 12 and 13, respectively. In one embodiment, core switches connect only to edge switches and do not connect to end user stations. In one embodiment, links 60-68 are Ethernet links and the switches transmit data across links 60-68 using Ethernet protocol.

In one embodiment, the links between edge switches 10-13 and core switches 30-40 are also coupled to high speed ports of the edge switches. Therefore, in this embodiment, links 60, 61 are coupled to high speed ports of edge switch 10, links 62, 66 are coupled to high speed ports of edge switch 11, etc. End user devices such as a personal computer 45, or additional edge devices such as switches may be coupled to the remaining lower speed ports of edge switches 10-13. Personal computer 45 is coupled to edge switch 10 via link 22. Other end user devices (not shown) can be coupled to links 23-26, or any of the other links that are coupled to unused ports of edge switches 10-13. In one embodiment, end user devices are only connected to one of the edge switches.

In one embodiment, switches 10-13, 30 and 40 are stackable switches that cooperate together to perform the function of a single large switch 50. The network topology formed by the linked switches of FIG. 1 is a Star-Wired-Matrix (“SWM”) topology. An SWM topology can be defined as M edge switches connected to N core switches or devices, each edge switch having N links connecting to each core and each core having M links connecting to each edge. An SWM topology has multiple paths between all devices in the network and therefore it can support higher bandwidth end-to-end compared to a star topology. An SWM topology has redundancy because all switches continue to have connectivity in the event of a core switch failure.

One drawback with an SWM topology such as network 50 of FIG. 1 is the presence of loops. A loop may arise because some switches, such as an Ethernet switch, will receive packets for which a destination cannot be determined. When this occurs, an Ethernet switch will send the packet on all links except for the source link. So, for example, if core switch 40 receives a packet with an unknown destination on link 60, switch 40 will transmit the packet on links 62-64. Multiple copies of the packet will then arrive at edge switches 11-13. Edge switches 11-13 may then transmit the packet to core switch 30 on multiple links if the switches also cannot determine the destination of the packet. Switch 30 then may transmit multiple copies of the packets to all of the edge switches again. Ultimately, packets will continue to circulate in the network as long as the destination of the packet continues to be unknown.

One embodiment of the present invention is a method for compensating for the loops formed in an SWM topology of Ethernet switches, as shown in FIG. 1. In one embodiment, all of the links at each edge switch that is coupled to a core switch are link aggregated together. Link aggregation is an Ethernet concept, standardized in Institute of Electrical and Electronic Engineers (“IEEE”) 802.3ad, in which the aggregated links function as a single logical link, and the corresponding ports function as a single logical port. Link aggregation may be implemented at each switch using link aggregation hardware in the switch. Therefore, links 60, 61 are aggregated together, links 62, 66 are aggregated together, etc.

Link aggregation of the edge switch links compensates for the loops in network 50 because it prevents duplicate copies of packets to arrive at the same edge switch. Link aggregation ensures that only one copy of the message is sent to the aggregated link. If any of the member links are inactive, link aggregation automatically distributes that message to the next available link. Therefore, the packet for which a destination cannot be resolved gets sent only to one core switch from an edge switch, eliminating the loop formation. In one embodiment, each core switch forwards packets as a standard Ethernet switch and the loop elimination of the network is accomplished by link aggregation programming of the edge switches.

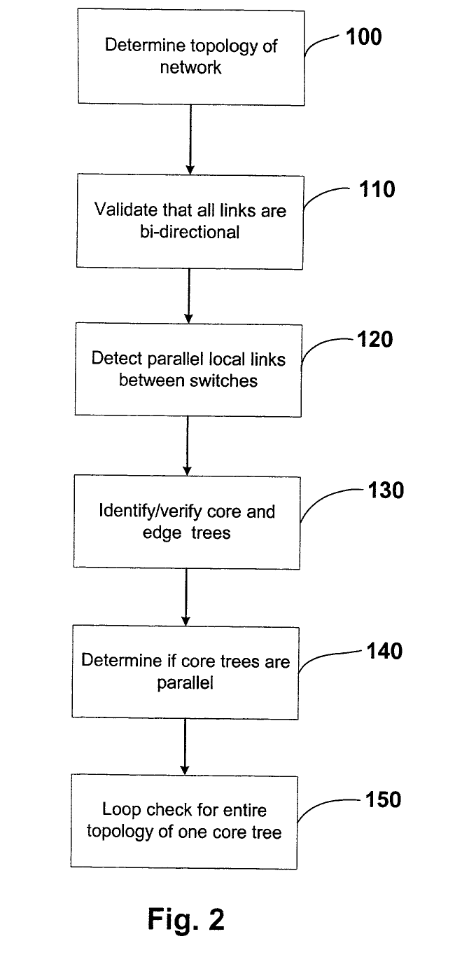

FIG. 2 is a flow diagram of the functionality performed by network 50 in accordance with one embodiment of the present invention. In one embodiment, the functionality is implemented by software stored in memory and executed by a processor on each of the switches of network 50 in parallel. In other embodiments, the functionality can be performed by hardware, or any combination of hardware and software.

The functionality of FIG. 2 can be executed whenever a network topology is first introduced or initiated or whenever a network topology is changed. The functionality can also be run continuously as the switches in the network are operated. The functionality determines which links in the network topology should be link aggregated in order to compensate for loops in the topology. The functionality deduces the connections of the topology into edge trees and parallel core trees, and then determines whether the core trees are parallel.

At box 100, the topology of network 50 is determined. In one embodiment, the topology is determined by an exchange of information between all switches so that each switch knows its neighbor. The composite of all neighbors determines the network topology

At box 110, all links between switches are checked to verify that they are bidirectional. In an embodiment in which the links are Ethernet links, the links must be bi-directional.

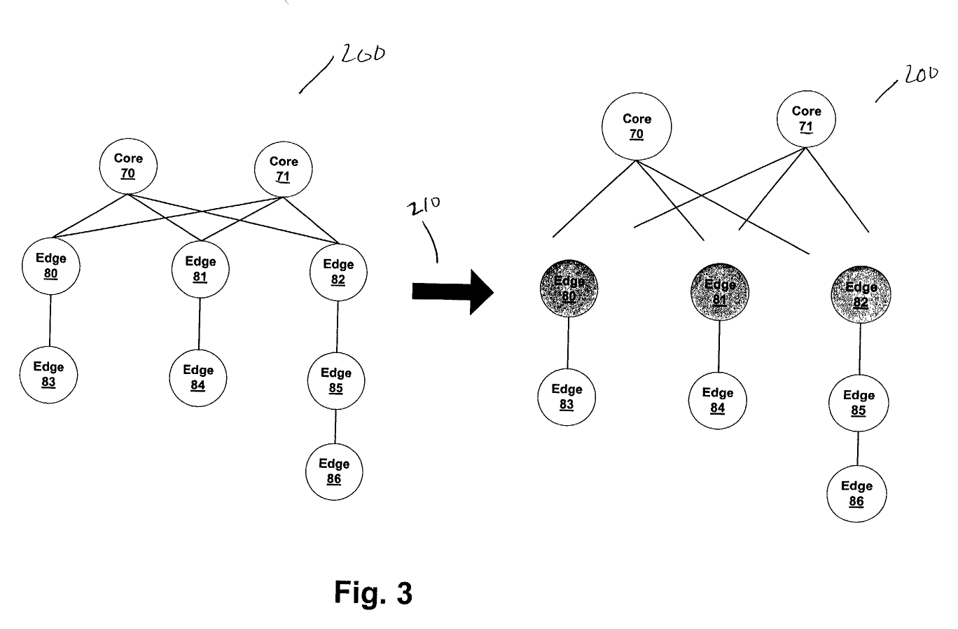

At box 120, all parallel local links between switches are determined. Parallel local links may be illustrated with reference to FIG. 3 which is an overview diagram of a switch topology network 200 that includes core switches 70 and 71, and edge switches 80-86. Parallel local links would be, for example, more than one link between edge switch 80 and core switch 70. The identified parallel local links are “real” aggregated links (as opposed to software link aggregated) and together are considered a single link for the remaining functions of FIG. 2.

At box 130, all core and edge trees are identified. A core tree is a tree consisting of only core switches. An edge tree is a tree consisting only of edge switches. A tree by definition does not include any loop. The topography should be able to be broken down into all core or edge trees. The illustration of network 200 to the right of arrow 210 shows the network broken down into two core trees (headed by core switches 70, 71) and three edge trees (headed by edge switches 80-82).

At box 140, it is determined whether the identified core trees are parallel. Core trees are parallel if they have an identical topology, and if each corresponding link of the core trees are coupled to the same edge trees.

At box 150, a final loop check is performed for one of the core trees and the edge trees connected to the core tree. If it is determined that there are no loops in the core tree or any of the edge trees, then the entire network has been compensated for any loops.

As described, a switch network in accordance to one embodiment of the present invention has an SWM topology and is compensated for loops by having all links from edge switches link aggregated together. A methodology can be executed to verify that the topology has been compensated for any loops.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A network comprising:
a plurality of edge switches;
one or more core switches; and
a plurality of core links that couple said edge switches to said core switches;
wherein said core links at each of said edge switches are link aggregated together.

2. The network of claim 1, wherein said edge switches, said core switches and said core links form a Star-Wired-Matrix topology.

3. The network of claim 1, wherein said plurality of core links are Ethernet links.

4. The network of claim 1, wherein said plurality of core links are bidirectional.

5. The network of claim 1, wherein each of said core switches form a core tree.

6. The network of claim 1, wherein each of said edge switches form an edge tree.

7. The network of claim 5, wherein said core trees are parallel.

8. A method of analyzing a network that comprises a plurality of edge switches and a plurality of core switches, said method comprising:
identifying a plurality of core trees and a plurality of edge trees;
determining whether the plurality of core trees are parallel; and
verifying that at least one of the core trees includes no loops within the network.

9. The method of claim 8, further comprising:
determining a topology of the network.

10. The method of claim 8, further comprising:
verifying that all links between the core switches and the edge switches are bidirectional.

11. The method of claim 8, further comprising:
identifying parallel local links between the core switches and the edge switches; and
classifying the parallel local links as a single link.

12. The method of claim 8, wherein links at each of the edge switch that are coupled to one of the core switches are link aggregated together.

13. The method of claim 8, wherein the network comprises a Star-Wired-Matrix topology.

14. A network comprising:
a first edge switch;
a first core switch and a second core switch;
a first link coupled to said first edge switch and said first core switch; and
a second link coupled to said first edge switch and said second core switch;
wherein said first link and said second link are link aggregated together.

15. The network of claim 14, wherein said network comprises a Star-Wired-Matrix topology.

16. The network of claim 1, wherein said first link and said second link are Ethernet links.

17. The network of claim 14, wherein said first core switch and said second core switch each form a core tree.

18. The network of claim 17, wherein said core trees are parallel.

19. The network of claim 14, wherein said edge switch forms an edge tree.

20. The network of claim 17, further comprising a third link coupled to said first edge switch and said first core switch, wherein said first link and said third link are considered a single link.
